(19) United States
(12) Patent Application Publication
(10) Pub. No.: US 2004/0266900 A1
(43) Pub. Date: Dec. 30, 2004

(54) Viscoelastic polyurethane foam

(76) Inventors: Raymond Neff, Northville, MI (US); Raghuram Gummaraju, Novi, MI (US); Theodore M. Smiecinski, Woodhaven, MI (US)

Correspondence Address: BASF CORPORATION, LEGAL DEPARTMENT, 1609 BIDDLE AVENUE, WYANDOTTE, MI, 48192, US

(21) Appl. No.: 10/606,825

(22) Filed: Jun. 26, 2003

(51) Int. Cl. C08J 9/00; C08G 18/00

(52) U.S. Cl. 521/155

(57) ABSTRACT

The subject invention provides a viscoelastic polyurethane foam having a density of from one to thirty pounds per cubic foot formed from a composition comprising an isocyanate component substantially free of toluene diisocyanate, an isocyanate-reactive component, and a chain extender having a backbone chain with from two to eight carbon atoms. The chain extender also has a weight-average molecular weight of less than 1,000 and is present in an amount of from 5 to 50 parts by weight based on 100 parts by weight of the composition. The viscoelastic polyurethane foam has a glass transition temperature of from 15 to 35 degrees Celsius and a tan delta peak of from 0.9 to 1.5.

### BACKGROUND OF THE INVENTION

1. Field of the Invention

The subject invention relates to a viscoelastic polyurethane foam having a density of from one to thirty pounds per cubic foot. More specifically, the subject invention relates to the viscoelastic polyurethane foam being formed of a composition having a chain extender that improves physical properties and viscoelasticity of the foam.

2. Description of the Related Art

Various related art viscoelastic foams are formed from a composition that is a reaction product of an isocyanate component and an isocyanate-reactive component reactive with the isocyanate component. These related art foams are illustrated in U.S. Pat. No. 6,204,300; European Patent Application No. 1,178,061; and PCT Publication WO 01/32736.

Viscoelastic polyurethane foam is currently a niche application in the United States. It is used mainly in home and office furnishings, although a considerable amount of work has been conducted for automotive applications. The market for viscoelastic foam in home furnishings applications is currently estimated at about 25 million lbs./yr. in the United States. While the market size is now relatively small, it is growing at an estimated rate of about 20% to 30% per year.

Viscoelastic foam exhibits slow recovery, and thus high hysteresis, during a compression cycle. They also typically have low ball rebound values. These properties may result from either low airflow, as the recovery is limited by the rate of air re-entering the foam, or by the inherent properties of the foamed polymer. Polymer viscoelasticity is usually temperature-sensitive, and is maximized when the polymer undergoes a glass transition. For the viscoelastic foams currently studied, this glass transition results from vitrification of the polyether soft segment phase. By manipulating the structure and composition of the soft segment phase so that the glass transition temperature approximately coincides with a “use temperature” of the material, the viscoelastic nature of the material is maximized. When this material is used in a mattress or as a seat cushion, body heat from the user warms a portion of the material, thus softening it. The result is that the cushion molds to the shape of the body part in contact with it, creating a more uniform pressure distribution, which increases comfort. In addition, the remainder of the material remains hard, providing support. Thus, the temperature sensitivity increases the effective support factor of the material, allowing the construction of a mattress without metal springs.

The type of isocyanate component and the functionality and hydroxyl value of the isocyanate-reactive component are selected and formulated such that the glass transition occurs at a temperature at which the foam is used. While most of the physical properties of viscoelastic foams resemble those of conventional foams, the resilience of viscoelastic foams is much lower, generally less than about 15%. Suitable applications for viscoelastic foam take advantage of its shape conforming, energy attenuating, and sound damping characteristics. One way to achieve these characteristics is to modify the amount and type of isocyanate-reactive components, isocyanate components, surfactants, catalysts, fillers as in U.S. Pat. No. 4,367,259, or other components, to arrive at foams having low resilience, good softness, and the right processing characteristics. Too often, however, the window for processing these formulations is undesirably narrow. These approaches are shown in U.S. Pat. Nos. 6,495,611 and 5,420,170. Other related art foams are shown in U.S. Pat. Nos. 4,334,031; 4,374,935; and 4,568,702; PCT Publication WO 01/25305; European Patent No. 0934962; and European Patent Application No. 1125958 and 0778301. However, none of these related art patents discloses or suggests the unique and novel polyurethane viscoelastic foam of the subject invention.

Other approaches to making viscoelastic foam hinge on finding the right mixture of polyether polyols and other components. For example, U.S. Pat. No. 4,987,156 arrives at a soft, low-resilience foam with a mixture of high and low molecular weight polyols, each of which has a hydroxyl functionality of at least 2, and a plasticizer having a solidification point less than −20 degrees C. However, the '156 patent does not disclose a viscoelastic foam and requires that the polyol and the isocyanate be reacted in the presence of the plasticizer. U.S. Pat. No. 5,420,170 teaches use of a mixture that includes one polyol having a hydroxyl functionality of 2.3-2.8 and another polyol having functionality 2-3. U.S. Pat. No. 5,919,395 takes a similar approach with a polyol mixture that contains a 2500 to 6500 weight-average molecular weight polyol having a functionality of 2.5 to 6 and a rigid polyol having molecular weight 300 to 1000 and a functionality of 2.5 to 6. Neither the '170 patent nor the '395 patent disclose adding a chain extender to the composition to modify the glass transition temperature of the foams.

Another related art composition is disclosed in a paper titled “Novel MDI-Based Slabstock Foam Technology” by Lutter and Mente. The composition disclosed produces a viscoelastic foam from an isocyanate-terminated prepolymer, a flexible polyol, and an ethylene-oxide rich polyol. However, the paper does not disclose a chain extender present in significant amounts to produce the viscoelastic foam having the improved properties.

Monols, such as monofunctional alcohols, have also been included in flexible polyurethane foams for various reasons, but they have rarely been used in a viscoelastic foam such as U.S. Pat. No. 6,391,935. The '935 patent discloses a TDI based viscoelastic foam and it does not disclose a foam substantially free of TDI. The '935 patent also does not disclose using a chain extender to modify the glass transition temperature of the foam. Most references that include a monol teach compositions that form foams having high resilience, such as U.S. Pat. Nos. 4.981,880, 3,875,086, and 3,405,077. However, none of these references disclose using a composition being substantially free of flame retardant that includes chain extenders to produce the viscoelastic foam.

Other references teach the use of low molecular weight monofunctional materials. For example, U.S. Pat. No. 5,631,319 teaches use of a C₁-C₂₅ monoalcohol combined with a hydroxyketone in non-viscoelastic foam. U.S. Pat. No. 4,209,593 teaches use of a naphthol or other “bulky” monohydroxy compound to make an energy-absorbing foam. Both the '319 patent and the '593 do not disclose a viscoelastic foam according to the subject invention. Unfortunately, including low molecular weight (<1000), high hydroxyl number (>60 mg KOH/g) monols in viscoelastic foams can adversely impact important foam properties, particularly compression sets. In addition, any monol can remain largely unreacted, especially in a low-index formulation, resulting in a foam that is oily to the touch and providing poor “hand feel”.

European Patent Application No. 0913414 discloses viscoelastic polyurethane foams that may contain a polyether monol. The monol, which has a molecular weight less than 1500, is used with a polyol that has a molecular weight greater than 1800. All of the examples produce foam having a low isocyanate index of less than 90. U.S. Pat. No. 4,950,695 teaches a monofunctional alcohol or polyether to soften flexible polyurethane foams. The formulations also include a 2000 to 6500 molecular weight triol. The '695 patent does not disclose a viscoelastic foam being flame retardant without additional flame retardant being added.

These foams are characterized by one or more inadequacies. Accordingly, it would be advantageous to provide a viscoelastic polyurethane foam that overcomes these inadequacies. Moreover, it would be advantageous to provide viscoelastic foam formed from a composition that is a reaction product of an isocyanate component and an isocyanate-reactive component and including a chain extender to improve the physical properties and viscoelasticity of the foam.

### BRIEF SUMMARY OF THE INVENTION AND ADVANTAGES

The subject invention provides a viscoelastic polyurethane foam having a density of from one to thirty pounds per cubic foot. The foam is a reaction product of an isocyanate component substantially free of toluene diisocyanate, an isocyanate-reactive component, and a chain extender having a backbone chain with from two to eight carbon atoms. The chain extender is also selected to have a molecular weight of less than 1,000. The chain extender is used in an amount of from 5 to 50 parts by weight based on 100 parts by weight of the composition. The composition produces the foam to have a glass transition temperature of from 5 to 65 degrees Celsius and a tan delta peak of from 0.40 to 1.75.

Accordingly, the subject invention provides the viscoelastic polyurethane foam as a reaction product of an isocyanate component, a isocyanate-reactive component, and a chain extender. The chain extender provides greater flexibility in producing the foam with a desired glass transition temperature that is closer to a use temperature of the foam. Further, the foam produced with the composition having the chain extender also has improved physical properties while maintaining viscoelasficity of the foam. Therefore, the subject invention overcomes the inadequacies that characterize the related art.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a graphical representation illustrating the effect of an amount of chain extender and an isocyanate index on a glass transition temperature of the viscoelastic polyurethane foam formed according to the subject invention;

FIG. 2 is a graphical representation illustrating the effect of increasing the amount of chain extender and increasing the isocyanate index on adjusting the DMTA properties of the viscoelastic polyurethane foam formed according to the subject invention;

FIG. 3 is a graphical representation illustrating a hardness of the viscoelastic polyurethane foam based upon increasing the amount of the chain extender and the isocyanate index;

FIG. 4 is a graphical representation illustrating the effect of increasing an amount of monol has on the glass transition of the viscoelastic polyurethane foam; and

FIG. 5 is a graphical representation illustrating the DMTA profile for the viscoelastic polyurethane foam prepared according to the subject invention compared with the DMTA profile for a commercial viscoelastic foam product.

### DETAILED DESCRIPTION OF THE INVENTION

The subject invention provides a viscoelastic polyurethane foam having a density of from one to thirty pounds per cubic foot (pcf). Preferably, the viscoelastic polyurethane foam has a density of from 2.5 to 25 pcf, and more preferably from 3 to 18. Various properties are measured to determine whether the foam is viscoelastic. One property is a glass transition temperature of the foam. The glass transition temperature is determined through a dynamic mechanical thermal analysis (DMTA). The glass transition temperature is typically about 5 to 50 degrees Celsius, preferably 10 to 40 degrees Celsius, and more preferably 15 to 35 degrees Celsius. The DMTA also produces a peak tan delta that indicates the ability of the foam to dissipate energy during a compression cycle and is related to a recovery time of the foam. The peak tan delta is about 0.3 to 1.8, preferably 0.4 to 1.75, and more preferably 0.9 to 1.5. The glass transition temperature and the peak tan delta result from vitrification of a soft segment phase of the foam. Vitrification manipulates the structure and composition of the soft segment phase so that the glass transition temperature approximately coincides with a use temperature of the foam, thereby maximizing the viscoelastic nature of the foam.

Additional physical properties that are advantageous, but not specifically related to the viscoelastic properties, include density, hardness, and recovery characteristics. A foam that has poor recovery characteristics will result in fingerprinting, i.e., fingerprints remain in the foam for long periods of time, such as greater than one minute, after handling. Also, the foam formed from the subject invention should have a surface that is not tacky and that does not have any oily residue detectable to the touch.

The foam of the subject invention is a reaction product of an isocyanate component substantially free of toluene diisocyanate with an isocyanate-reactive component and a chain extender. Those skilled in the art recognize that the foam is formed from a composition including the isocyanate component, the isocyanate-reactive component, and the chain extender. References herein below to amounts of these components may be to either the foam or the composition, since mass must be balanced throughout the reaction as is understood by those skilled in the art.

It is to be appreciated that substantially free of toluene diisocyanate means less than 8 parts by weight based on 100 parts by weight of the isocyanate component and preferably less than 5 parts by weight based on 100 parts by weight of the isocyanate component. More preferably, the isocyanate component is completely free of toluene diisocyanate, i.e., 0 parts by weight based on 100 parts by weight of the isocyanate component.

However, it is to be understood that the foam may include a minimal amount of toluene diisocyanate, without effecting the viscoelastic performance characteristics of the polyurethane foam. An isocyanate index, as is known in the art, is the ratio of NCO groups in the isocyanate component to the OH groups in the isocyanate-reactive component. Preferably, the isocyanate index is from 75 to 110 and more preferably from 80 to 105. One skilled in the art would appreciate that the amount of isocyanate component can be determined by the isocyanate index in combination with the amount of isocyanate-reactive component present.

Preferably, the isocyanate component is selected from at least one of pure diphenylmethane diisocyanate and polymeric diphenylmethane diisocyanate. Pure diphenylmethane diisocyanate is understood by those skilled in the art to include diphenylmethane-2,4′-diisocyanate and diphenylmethane-4,4′-diisocyanate. Polymeric diphenylmethane diisocyanate is understood by those skilled in the art to include polycyclic polyisocyanates having 3-ring compounds, 4-ring compounds, 5-ring compounds, and higher homologs. In one embodiment, the pure diphenylmethane diisocyanate is present in an amount of from 50 to 99 parts by weight based on 100 parts of the isocyanate component and the polymeric diphenylmethane diisocyanate is present in an amount from 1 to 50 parts by weight based on 100 parts of the isocyanate component. The pure diphenylmethane diisocyanate includes the diphenylmethane-2,4′-diisocyanate present in an amount of from 1 to 45 parts by weight based on 100 parts of the pure diphenylmethane diisocyanate and the diphenylmethane-4,4′-diisocyanate present in an amount from 55 to 99 parts by weight based on 100 parts of the pure diphenylmethane diisocyanate. An example of suitable isocyanates include, but are not limited to, LUPRANATE® MS, LUPRANATE® M20S, LUPRANATE® MI, and LUPRANATE® M10 LUPRANATE® M70 and LUPRANATE® M200 isocyanates, and No. 236 isocyanate, No. 233 isocyanate and No. 278 isocyanate, which are commercially available from BASF Corporation.

In another embodiment, the isocyanate component may be added as an isocyanate-terminated prepolymer. The prepolymer is a reaction product of an isocyanate and a polyol. The polyol has a weight-average molecular weight greater than 1,000 and is present in an amount of from 1 to 20 parts by weight based on 100 parts of the isocyanate component. The polyol may be selected from at least one of ethylene glycol, diethylene glycol, propylene glycol, dipropylene glycol, butane diol, glycerol, trimethylolpropane, triethanolamine, pentaerythritol and sorbitol. The polyol may also be a polyamine selected from, but not limited to, ethylene diamine, toluene diamine, diaminodiphenylmethane and polymethylene polyphenylene polyamines, and aminoalcohols. Examples of aminoalcohols include ethanolamine and diethanolamine, triethanolamine, and mixtures thereof. An example of suitable polyols include, but are not limited to, PLURACOL® 2100, PLURACOL® 2115, PLURACOL® 2120, and PLURACOL® 2130, PLURACOL® 2145, PLURACOL® 593, PLURACOL® 945, PLURACOL® 1509, PLURACOL® 1051, PLURACOL® 1385, PLURACOL® 381, PLURACOL® 726, PLURACOL® 220, PLURACOL® 718, PLURACOL® 1718, PLURACOL® 1442, and PLURACOL® 1117 Polyols, which are commercially available from BASF Corporation.

The isocyanate-reactive component includes a polyol selected from at least one of polyether polyols and polyester polyols. Preferably, the polyol has a hydroxyl number of from 20 to 200 mg KOH per gram of the polyol. The polyol is formed with an initiator, as is known in the art, and may be selected from at least one of ethylene glycol, diethylene glycol, propylene glycol, dipropylene glycol, butane diol, glycerol, trimethylolpropane, triethanolamine, pentaerythritol and sorbitol. The polyol may also be a polyamine selected from, but not limited to, ethylene diamine, toluene diamine, diaminodiphenylmethane and polymethylene polyphenylene polyamines, and aminoalcohols. Examples of aminoalcohols include ethanolamine and diethanolamine, triethanolamine, and mixtures thereof.

The polyester polyols may be obtained by the condensation of appropriate proportions of glycols and higher functionality polyols with polycarboxylic acids. Still further suitable polyols include hydroxyl-terminated polythioethers, polyamides, polyesteramides, polycarbonates, polyacetals, polyolefins and polysiloxanes. Preferred polyols are the polyether polyols comprising ethylene oxide and/or propylene oxide groups. Other polyols that may be used include dispersions or solutions of addition or condensation polymers in polyols of the types described above. Such modified polyols, often referred to as “polymer” polyols, have been fully described in the prior art and include products obtained by the in-situ polymerization of one or more vinyl monomers, for example styrene and acrylonitrile, in polymeric polyols, for example polyether polyols, or by the in situ reaction between a polyisocyanate and an amino- or hydroxy-functional compound, such as triethanolamine, in a polymeric polyol.

It is preferred that the isocyanate-reactive component includes an ethylene-oxide (EO) rich polyol and a flexible polyol. The EO-rich polyol has an ethylene oxide group content of from 40 to 95%, as understood by those skilled in the art, preferably from 50 to 90%, and more preferably from 65 to 85%. The flexible polyol has a hydroxyl number of less than 110. Examples of suitable EO-rich polyols include, but are not limited to, PLURACOL® 593 and PLURACOL® 1123, Polyols, which are commercially available from BASF Corporation. Examples of suitable flexible polyols include, but are not limited to, PLURACOL® 2100, PLURACOL® 380, PLURACOL® 2115, PLURACOL® 2120, and PLURACOL® 2130, PLURACOL® 2145, PLURACOL® 945, PLURACOL® 1509, PLURACOL® 1051, PLURACOL® 1385, PLURACOL® 1538, PLURACOL® 381, PLURACOL® 726, PLURACOL® 220, PLURACOL® 718, PLURACOL® 1718, PLURACOL® 1442, PLURACOL® 1117, and PLURACOL® 1135 Polyols, which are commercially available from BASF Corporation.

The composition further includes a chain extender having a backbone chain with from two to eight carbon atoms. Preferably, the backbone chain is has from two to six carbon atoms. The chain extender also has a weight-average molecular weight of less than 1,000. Preferably, the chain extender has a weight-average molecular weight of from 25 to 250 and more preferably less than 100. The chain extender may be present in an amount of from 5 to 50 parts by weight based on 100 parts by weight of the composition, preferably from 5 to 30, and more preferably 5 to 15.

The chain extender has two isocyanate-reactive groups. Preferably, the chain extender is a diol having hydroxyl groups as the isocyanate-reactive groups. More preferably, the chain extender is selected from at least one of 1,4-butanediol, 1,3-butanediol, 2,3-butanediol, 1,2-butanediol, 1,3-propylene glycol, 1,5-pentanediol, ethylene glycol, diethylene glycol, and polyethylene glycols having a weight-average molecular weight of up to 200. One suitable example of a commercially available chain extender is NIAX® DP-1022 from Crompton OSI.

The chain extender increases the glass transition temperature (Tg) of the foam. The chain extender and the isocyanate component react to form urethane hard segments within the foam that are incorporated into the soft segment phase and raise the soft segment Tg. This allows adjustment of Tg over a wide range of temperatures, independent of a density of the foam, which was not previously possible. The subject invention provides flexibility to produce foams with a wide range of Tg's, by adjusting the chain extender level. It should be noted that in addition to adjusting the chain extender level, raising the isocyanate index also raises Tg. By simultaneously adjusting the isocyanate index, both the Tg and hardness can be independently varied.

The composition may further include a cross-linker. If included, the cross-linker is present in an amount of from 2 to 18 parts by weight based on 100 parts by weight, preferably from 4 to 16, more preferably from 4 to 15. Preferably, the cross-linker is an amine-based cross-linker and even more preferably, the amine-based cross-linker is selected from at least one of triethanolamine, diethanolamine, ethylene diamine alkoxylation products thereof having a hydroxyl number greater than 250. However, it is to be appreciated that other types of cross-linkers other than amine-based cross-linkers may be used in the subject invention. A polyol having a hydroxyl number of greater than 250 and a functionality greater than 2 may be used as the cross-linker in the subject invention. A suitable cross-linker is, but not limited to, Pluracol® 355, commercially available from BASF Corporation.

A monol may also be included in the composition and, if included, is present in an amount of from 1 to 15 parts by weight based on 100 parts by weight of the composition to increase the tan delta peak of the foam. Preferably, the monol is selected from at least one of benzyl alcohol, 2,2-dimethyl-1,3-dioxolane-4-methanol, and alcohol ethoxylate. Increasing the monol increases peak tan delta of the foam, while also softening the foam and slowing recovery. Tg also increases with the increasing amount of the monol, which forms more urethane, relative to the other resin side components, due to its high hydroxy content. The monol may also include other typical surfactants. An example of a suitable monol includes, but is not limited to, Solketal commercially available from Chemische Werke Hommel GmbH, ICONOL™ DA-4, ICONOL™ DA-6, MACOL® LA4, PLURAFAC® RA-40, PLURAFAC® LF4030, and INDUSTROL® TFA-8 all of which are commercially available from BASF Corporation.

The composition may include a cell opener having from at least one of a paraffinic, cyclic, and aromatic hydrocarbon chain and, if included, is present in an amount of from 1 to 15 parts by weight based on 100 parts by weight of the composition, preferably from 1 to 12, and more preferably from 3 to 12. Preferably, the cell opener is mineral oil. However, other cell openers may be used which include, but are not limited to, silicone oils, corn oil, palm oil, linseed oil, soybean oil and defoamers based on particulates, such as silica. Foams formed with the cell opener are noticeably less tacky than those without the cell opener and the foams did not have an oily residue. It has been determined that foams containing less than 2.5 parts by weight of the cell opener based on 100 parts by weight of the composition have fewer tendencies to retain fingerprints after handling. However, it is to be appreciated that modifying the other components of the composition may also effect fingerprinting. The cell opener increased the airflow through the foam and decreased the recovery time of the foam. It also lowered compression sets. One example of a suitable cell opener is white, light mineral oil commercial available from Mallinckrodt Chemicals.

The composition may further include other additives such as stabilizers or catalysts as is known to those skilled in the art. Examples of suitable stabilizers are, but not limited to, TEGOSTAB® B-8409 and TEGOSTAB® B-8418, both commercially available from Goldschmidt Chemical Corporation. Examples of cross-linkers include, but are not limited to, DABCO® 33LV or DABCO® BL-11 commercially available from Air Products and Chemicals, Inc.

The foam formed from the composition according to the subject invention has a glass transition temperature of from 5 to 65 degrees Celsius and a tan delta peak of from 0.40 to 1.75, as will be described more fully below. As previously described, the amount of the chain extender present in the composition effects the temperature at which the glass transition occurs and also effects the tan delta peak of the foam. When the chain extender is present in the preferred amounts described above, the foam has a glass transition temperature of from 15 to 35 degrees Celsius and a tan delta peak of from 0.9 to 1.5. It is preferable to select, formulate, and modify the amount of chain extender and monol such that the foam has the glass transition at a temperature that the foam is to be used. This is particularly important when considering that the foam may be used in areas having varying temperatures and it might be advantageous to modify the composition so that the foam is better suited for the specific temperatures. The “use temperature” may be based upon body temperature, time of year, geographic location, or all of the above.

The subject invention further provides a method of forming a viscoelastic polyurethane foam comprising the steps of providing the isocyanate component substantially free of flame retardant, providing the isocyanate-reactive component, and providing the chain extender described above. The method further includes the step of reacting the isocyanate component, the isocyanate-reactive component, and the chain extender to form the foam having a glass transition temperature of from 5 to 65 degrees Celsius and a tan delta peak of from 0.40 to 1.75.

### EXAMPLES

A viscoelastic polyurethane foam was formed according to the subject invention. Each of the components forming the composition is listed in parts by weight, unless otherwise indicated. As set forth above, the isocyanate index is the ratio of —NCO groups in the isocyanate component to the —OH groups in the isocyanate-reactive component.

Table 1 represents the general formulation that is further described in the following examples. The base formulation is modified as shown in the following examples by modifying the amounts of Polyol C, chain extender, cross-linker, monol, water, and by varying the isocyanate index. Unless otherwise noted in the following tables, the amount of water used was 1.4 pbw and the amount of catalyst 2 used was 0.2 pbw.

TABLE 1
Base Formulation

| Component | Amount |
|---|---|
| Polyol A | 90 |
| Polyol B | 10 |
| Cross-linker | 12 |
| Chain Extender | 5-15 |
| Catalyst 1 | 0.25 |
| Catalyst 2 | 0.1-0.2 |
| Stabilizer | 3 |
| Monol | 8 |
| Water | 1.4-1.6 |
| Isocyanate Component Index | 80-105 |

Polyol A is PLURACOL® 593 Polyol having a functionality of 2.96, a weight-average molecular weight of 3606, hydroxyl number of 460, and 75% EO-25% PO heteric, commercially available from BASF Corporation, and Polyol B is PLURACOL® 220 Polyol having a functionality of 3, a weight-average molecular weight of 6000, hydroxyl number of 25, and 5% EO-95% PO heteric, commercially available from BASF Corporation. Cross-linker is PLURACOL® 355 Polyol having a functionality of 3.96, a weight-average molecular weight of 491, hydroxyl number of 453, and 10% EO-77.9% PO, commercially available from BASF Corporation. The isocyanate component is a mixture of 48.7 parts by weight of Isocyanate No. 233, 31.6 parts by weight of LUPRANATE® MI, and 19.7 parts by weight LUPRANATE® M20S Isocyanates, each commercially available from BASF Corporation. The chain extender is 1,4-butanediol. The additive is a stabilizer, TEGOSTAB® B-8418, commercially available from Goldschmidt Chemical Corporation. Catalyst 1 is NIAX® A-1, commercially available from Crompton OSI and Catalyst 2 is DABCO® 33LV commercially available from Air Products and Chemicals, Inc. The monol is benzyl alcohol.

As discussed in the following examples, the foams were prepared in hand-mixes using standard hand-mix techniques. In the hand mixtures, all components, except isocyanate, were added into a 64-oz. paper cup and pre-blended for 48 seconds using a 3-inch diameter circular mix blade rotating at 2200 rpm. The isocyanate component was then added, then mixed for 8 seconds. The mixture was then poured into a 5-gallon bucket and allowed to cure for at least 30 minutes at room temperature. The foams were then placed into an oven set at 250° F. for 16 hours. Where indicated in the below tables, some foams were made using the M-30 laboratory-scale slabstock machine. These machine prepared foams were removed from the conveyor after 20 minutes, and allowed to cure overnight before cutting. No crushing was performed on any of the foams described in these examples. Physical property tests were conducted in accordance with the ASTM references listed below.

Various physical properties were measured for the foam produced in accordance with the subject invention. Density was measured according to ASTM D1622. Indentation force deflection (IFD) was measured at 25%, 50%, 65%, and 25% Return according to ASTM D3574. Block tear was measured in accordance with ASTM D1938. Tensile strength was determined in accordance with ASTM D3574. Falling ball resilience was measured in accordance with ASTM D3574. Frazier air flow was determined in accordance with ASTM D737. Compression sets were determined in accordance with ASTM D395 and beat aging was determined in accordance with D3574. The DMTA was measured in accordance with D4065 using a Rheometrics RSA II and disk-shaped samples 2 cm wide by ½ inch thick were die cut for the measurements. A strain of 0.5%, frequency 1 Hz and heating rate 5° C./min were used.

Table 2 illustrates the base formulation shown in Table 1 with the chain extender present in an amount of from 0 to 7.5 parts by weight based on 100 parts by weight of the composition, the water present at an amount of either 2.42 or 2.80, and the isocyanate index is either 90 or 95. The resulting physical properties were measured for each of the examples and listed below.

TABLE 2
Effect of Chain Extender and Isocyanate Index on Tg

| | Example 1 | Example 2 | Example 3 | Example 4 | Example 5 | Example 6 | Example 7 | Example 8 |
|---|---|---|---|---|---|---|---|---|
| Water | 2.42 | 2.42 | 2.80 | 2.80 | 2.42 | 2.42 | 2.80 | 2.80 |
| Chain | 2.5 | 2.5 | 5 | 5 | 7.5 | 7.5 | 0 | 0 |
| Extender | | | | | | | | |
| Isocyanate | 74.4 | 78.5 | 87.0 | 91.9 | 88.8 | 93.7 | 72.6 | 76.7 |
| Isocyanate | 90 | 95 | 90 | 95 | 90 | 95 | 90 | 95 |
| Index | | | | | | | | |
| Physical | | | | | | | | |
| Properties | | | | | | | | |
| Core Density, | 3.50 | 3.30 | 3.30 | 3.10 | 3.80 | 3.60 | 3.10 | 2.90 |
| pcf | | | | | | | | |
| Frazier Air | 2.00 | 1.30 | 7.70 | 2.30 | 0.50 | 0.30 | 10.90 | 1.50 |
| Flow, cfm | | | | | | | | |
| Orig. Peak | 5.50 | 7.30 | 7.90 | 8.90 | 7.70 | 11.30 | 6.10 | 7.20 |
| Tensile, psi | | | | | | | | |
| Orig. Break | 117.00 | 117.00 | 134.00 | 114.00 | 119.00 | 116.00 | 131.00 | 115.00 |
| Elong., % | | | | | | | | |
| Original | 0.86 | 0.94 | 1.06 | 1.54 | 1.09 | 1.32 | 0.72 | 0.84 |
| Block Tear, | | | | | | | | |
| ppi | | | | | | | | |
| Falling Ball | 3.00 | 2.00 | 3.00 | 4.00 | 3.00 | 3.00 | 3.00 | 4.00 |
| Resilience, % | | | | | | | | |
| Orig 50% | 0.15 | 0.17 | 0.16 | 0.19 | 0.21 | 0.27 | 0.13 | 0.14 |
| CFD, psi | | | | | | | | |
| 50% | 4.40 | 3.20 | 5.00 | 4.80 | 4.30 | 2.60 | 4.40 | 4.10 |
| Compression | | | | | | | | |
| Set | | | | | | | | |
| (22 HRS., | | | | | | | | |
| 158° F.), % | | | | | | | | |
| Heat Aged | 7.50 | 9.60 | 9.40 | 11.30 | 12.80 | 13.50 | 6.60 | 6.30 |
| Peak Tensile | | | | | | | | |
| (22 HRS., | | | | | | | | |
| 250° F.), psi | | | | | | | | |
| Heat Aged | 108.00 | 106.00 | 114.00 | 104.00 | 111.00 | 111.00 | 102.00 | 104.00 |
| Elongation, % | | | | | | | | |
| Tg, ° C. | 18.10 | 22.70 | 28.80 | 33.90 | 29.10 | 31.10 | 15.60 | 20.30 |
| Peak Tan | 1.03 | 0.97 | 1.01 | 0.93 | 1.06 | 0.99 | 0.95 | 0.91 |
| Delta | | | | | | | | |

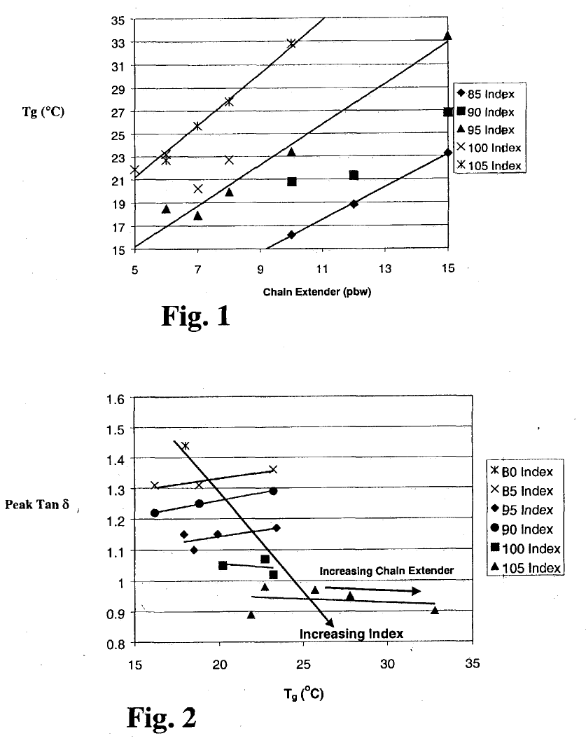

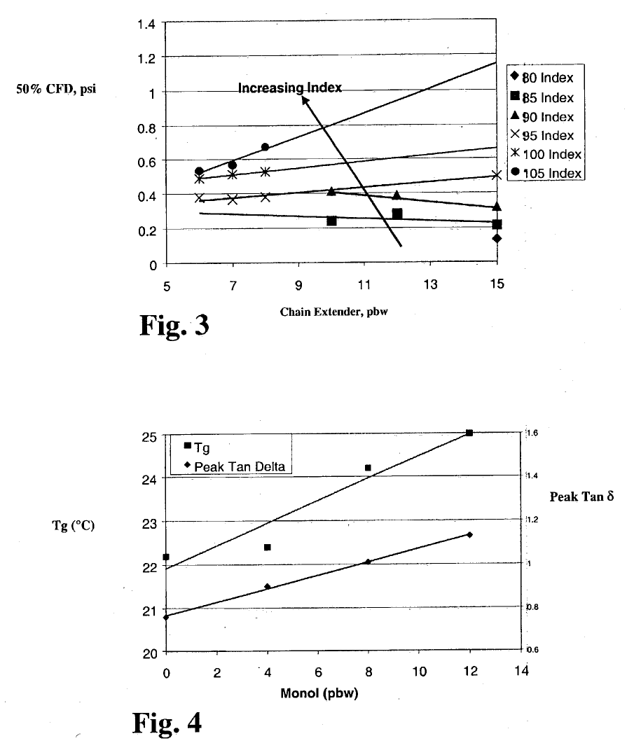

Referring to FIGS. 1, 2, and 3, the results from Table 2 are graphically illustrated. Generally, as the amount of chain extender is increased, the Tg of the foam increases. Also, as the isocyanate index is increased, the Tg of the foam increases. The peak tan delta of the foam generally decreases with increasing isocyanate index, while the amount of chain extender does not materially effect the peak tan delta. The hardness of the foam is not substantially effected by increasing the amount of the chain extender for an isocyanate index of 100 or less. When the isocyanate index is 105, the hardness increases by increasing the amount of the chain extender. The amount of water is varied to modify the density of the foam.

Table 3 illustrates the effect of the amount of chain extender and the isocyanate index on the shrinkage of the foam.

TABLE 3
Effect of Chain Extender and Isocyanate Index on Shrinkage
of the Foam

| | | | | Shrinkage |
|---|---|---|---|---|
| | Chain | | Isocyanate | (None, slight, |
| | Extender | Isocyanate | Index | moderate, severe) |
| Example 9 | 12 | 88.5 | 90 | None |
| Example 10 | 5 | 69.8 | 95 | None |
| Example 11 | 10 | 85.0 | 95 | Slight |
| Example 12 | 7 | 80.7 | 100 | Slight |
| Example 13 | 10 | 85.0 | 105 | Moderate |
| Example 14 | 5 | 77.2 | 105 | Severe |

From Table 3 it can be determined that increasing the isocyanate index increases the tendency of the foam to shrink. However, it appears that by increasing the amount of the chain extender, the shrinkage at the high isocyanate index can be reduced.

Table 4 illustrates the effect of the varying the amount of Polyol C has on the physical properties and viscoelasticity of the foam. In table 4, Catalyst 2 is present in an amount of 0.1 pbw.

TABLE 4
Effect of the amount of Polyol C on Tg and Shrinkage of
the Foam

| | Example | Example | Example | Example |
|---|---|---|---|---|
| | 15 | 16 | 17 | 18 |
| Polyol C, pbw | 0 | 5 | 10 | 15 |
| Chain Extender, pbw | 7 | 7 | 7 | 7 |
| Isocyanate | 80.1 | 80.4 | 80.7 | 81.0 |
| Isocyanate Index | 100 | 100 | 100 | 100 |
| Physical Properties | | | | |
| Shrinkage | None | None | Slight | None |
| (None, slight, moderate, | | | | |
| severe) | | | | |
| Core Density, pcf | 4.80 | 5.10 | 5.30 | 5.30 |
| Frazier Air Flow, cfm | 2.60 | 0.80 | 0.40 | 0.40 |
| Orig. Peak Tensile, psi | 10.40 | 10.40 | 11.50 | 11.20 |
| Orig. Break Elong., % | 103.00 | 101.00 | 106.00 | 109.00 |
| Original Block Tear, ppi | 0.83 | 0.67 | 0.68 | 0.61 |
| Falling Ball Resilience, | 3.00 | 3.00 | 3.00 | 3.00 |
| % | | | | |
| Orig 50% CFD, psi | 0.48 | 0.46 | 0.51 | 0.48 |
| 50% Compression Set | 1.10 | 1.10 | 0.70 | 1.00 |
| (22 HRS., 158° F.), % | | | | |
| Heat Aged Peak Tensile | 10.40 | 9.40 | 9.20 | 9.00 |
| (22 HRS., 250° F.), psi | | | | |
| Heat Aged Elongation, % | 138.00 | 132.00 | 135.00 | 127.00 |
| Tg, ° C. | 22.40 | 22.00 | 24.10 | 22.70 |
| Peak Tan Delta | 1.03 | 1.05 | 1.01 | 1.04 |

Increasing the amount of Polyol C tends to increase the density of foam, while also improving the tensile and elongation. However, increasing the amount of Polyol C decreases the Frazier Air Flow. The viscoelasticity of the foam appears to not be effected by increasing the amount of Polyol C.

Table 5 illustrates the physical properties of a foam produced from the formulation of Table 1 with the chain extender being present in an amount of 12 parts by weight based on 100 parts by weight of the composition and having an isocyanate index of 95. Example 19 has no additional flame retardant, while Example 20 has flame retardant present in an amount of 6 parts by weight based on 100 parts by weight of the composition. The foams of Examples 19 and 20 were produced by the machine described above.

TABLE 5
Properties of Foam having 12 pbw Chain Extender

| | Example 19 | Example 20 |
|---|---|---|
| Physical Properties | | |
| Density, pcf | 6.20 | 5.70 |
| Dow Airflow, cfm | 0.09 | 0.06 |
| Tensile, psi | 11.90 | 16.60 |
| HA Tensile, psi | 11.30 | 18.10 |
| Elongation, % | 160.50 | 120.80 |
| Tear | 1.40 | 1.80 |
| Resilience, % | 2.00 | 2.00 |
| Compression Sets, % | | |
| 50% | 2.00 | 1.00 |
| 90% | 2.00 | 2.00 |
| CFD, 50%, psi | 0.41 | 0.58 |
| Humid Aged 3 @ 220 F. | | |
| CFD, % of 50% | 46.00 | 55.00 |
| Compression Sets | | |
| 50% | 5.00 | 3.00 |
| 90% | 6.00 | 5.00 |
| Fatigue Properties | | |
| Frazier, cfm/ft2 | | |
| Before fatigue | 3.96 | 2.04 |
| After fatigue | 5.40 | 6.90 |
| Recovery Time, Sec. | | |
| 4-inch thickness | 22.00 | 14.00 |
| 2-inch thickness Before fatigue | 16.00 | 6.00 |
| 2-inch thickness After fatigue | 15.00 | 4.00 |
| Catastophic Fatigue (12K cycles) | | |
| Height, % Loss | 0.00 | 0.00 |
| 75% IFD, % Loss | 2.43 | 4.70 |
| Tan Delta | 1.22 | 1.03 |
| Tg Temp, C. | 22.50 | 30.30 |
| Flammability | | |
| California TB 117 | | |
| Vertical Open Flame | FAIL | FAIL |
| Char Length Ave, in. | 5.00 | 4.00 |
| After flame Ave, sec. | 46.00 | 38.00 |
| HA Char Length Ave, in. | 5.00 | 4.00 |
| HA after flame Ave, sec. | 46.00 | 38.00 |
| Cigarette Smoldering, % wt. Ret. | PASS | PASS |

It should be appreciated that both Examples 19 and 20 do not pass the vertical open flame test, but do pass the cigarette smoldering test, both tests known to those skilled in the art. Even though Example 20 did not pass the vertical open flame test, the char length and after flame were improved compared to Example 19.

Table 6 illustrates the effect of varying the amounts of monol present in the composition. The following examples were formed in accordance with the formulation in Table 1 having the chain extender present in an amount of 7 parts by weight based upon 100 parts by weight of the composition and having an isocyanate index of 100. In table 6, Catalyst 2 is present in an amount of 0.1 pbw.

TABLE 6
Effect of the amount of Monol on the Foam

| | Example | Example | Example | Example |
|---|---|---|---|---|
| | 21 | 22 | 23 | 24 |
| Isocyanate | 75.4 | 75.4 | 80.7 | 86.0 |
| Monol, pbw | 0 | 4 | 8 | 12 |
| Physical Properties | | | | |
| Core Density, pcf | 5.10 | 5.10 | 5.30 | 5.60 |
| Frazier Air Flow, cfm | 0.30 | 0.40 | 0.40 | 0.70 |
| Orig. Peak Tensile, psi | 12.50 | 10.80 | 11.50 | 9.30 |
| Orig. Break Elong., % | 65.00 | 78.00 | 106.00 | 114.00 |
| Original Block Tear, ppi | 0.40 | 0.55 | 0.68 | 0.95 |
| Falling Ball Resilience, | 8.00 | 5.00 | 3.00 | 2.00 |
| % | | | | |
| Orig 50% CFD, psi | 1.06 | 0.74 | 0.51 | 0.37 |
| 50% Compression Set | 0.10 | 0.30 | 0.70 | 2.50 |
| (22 HRS., 158° F.), % | | | | |
| Heat Aged Peak Tensile | 8.60 | 8.80 | 9.20 | 9.60 |
| (22 HRS., 250° F.), psi | | | | |
| Heat Aged Elongation, % | 99.00 | 117.00 | 135.00 | 143.00 |
| Tg, ° C. | 22.20 | 22.40 | 24.20 | 25.00 |
| Peak Tan Delta | 0.76 | 0.90 | 1.01 | 1.13 |

Referring to FIG. 4, the above results are graphically illustrated. Generally, increasing the amount of the monol improves both the Tg and the peak tan delta of the foam resulting in improved viscoelasticity. Increased monol also decreases the hardness of the foam making it softer, however, it also decreases the tensile, elongation, and tear strength of the foam.

Table 7 illustrates the effect of the amount of cross-linker present and the resulting effect on Tg. The foam was prepared in accordance with the formulation of Table 1, except that no polyol B is present. The chain extender is present in an amount of 7 parts by weight based on 100 parts by weight of the composition. The isocyanate index is 100. In table 7, Catalyst 2 is present in an amount of 0.1 pbw Dabco 33LV. Also, the cross-linker is triethanolamine (TEOA) instead of Pluracol 355.

TABLE 7
Effect of Cross-linker on Tg of the Foam

| | Example | Example | Example |
|---|---|---|---|
| | 25 | 26 | 27 |
| Cross-linker, pbw | 2 | 4 | 6 |
| Chain Extender, pbw | 7 | 7 | 7 |
| Isocyanate, pbw | 72.6 | 78.4 | 84.2 |
| Isocyanate Index | 100 | 100 | 100 |
| Physical Properties | | | |
| Shrinkage | None | None | None |
| Core Density, pcf | 5.00 | 5.20 | 5.40 |
| Frazier Air Flow, cfm | 6.40 | 3.30 | 2.90 |
| Orig. Peak Tensile, psi | 7.40 | 8.40 | 8.70 |
| Orig. Break Elong., % | 135.00 | 127.00 | 96.00 |
| Original Block Tear, ppi | 0.48 | 0.73 | 0.70 |
| Falling Ball Resilience, % | 3.00 | 4.00 | 3.00 |
| Orig 50% CFD, psi | 0.28 | 0.35 | 0.48 |
| 50% Compression Set | 1.60 | 0.30 | 0.60 |
| (22 HRS., 158° F.), % | | | |
| Heat Aged Peak Tensile | 8.70 | 11.00 | 15.10 |
| (22 HRS., 250° F.), psi | | | |
| Heat Aged Elongation, % | 141.00 | 119.00 | 110.00 |
| Tg, ° C. | 16.00 | 18.20 | 25.80 |
| Peak Tan Delta | 1.07 | 1.05 | 0.98 |

From Table 7 it can be determined that by increasing the amount of cross-linker increases the Tg, but decreases the peak tan delta. It is desirable to maintain a higher peak tan delta since it indicates the ability of the foam to dissipate energy during a compression cycle and is related to a recovery time. The Frazier Air Flow was also decreased in response to increasing the amount of the cross-linker. Also derived from Table 7, in connection with Table 6, Example 23, is that Example 27 with 6 parts by weight TEOA yields similar properties to Example 23 with 12 parts by weight Pluracol 355.

Table 8 illustrates the effect of cell opener on the foam. The foam was prepared in accordance with the formulation of Table 1. The chain extender is present in an amount of 7 parts by weight based on 100 parts by weight of the composition and the isocyanate index is 100. In table 8, Catalyst 2 is present in an amount of 0.1 parts by weight and the isocyanate is present in an amount of 80.7 parts by weight.

TABLE 8
Effect of Cell Opener on the Foam

| | Example | Example | Example |
|---|---|---|---|
| | 28 | 29 | 30 |
| Cell Opener, pbw | 0 | 5 | 10 |
| Physical Properties | | | |
| Core Density, pcf | 5.30 | 5.60 | 5.70 |
| Frazier Air Flow, cfm | 0.40 | 6.20 | 10.70 |
| Orig. Peak Tensile, psi | 11.50 | 9.80 | 10.30 |
| Orig. Break Elong., % | 106.00 | 101.00 | 111.00 |
| Original Block Tear, ppi | 0.68 | 0.74 | 0.69 |
| Falling Ball Resilience, % | 3.00 | 3.00 | 3.00 |
| Orig 50% CFD, psi | 0.51 | 0.52 | 0.48 |
| 50% Compression Set | 0.70 | 0.20 | 0.80 |
| (22 HRS., 158° F.), % | | | |
| Heat Aged Peak Tensile | 9.20 | 9.90 | 10.90 |
| (22 HRS., 250° F.), psi | | | |
| Heat Aged Elongation, % | 135.00 | 158.00 | 148.00 |
| Tg, ° C. | 24.20 | 24.80 | 24.50 |
| Peak Tan Delta | 1.01 | 1.02 | 1.04 |

Increasing the amount of the cell opener appears to not effect the viscoelasticity of the foam based upon the Tg and the peak tan delta. However, increasing the amount of the cell opener does increase the amount of air flow through the foam, which indicates that it has improved recovery from compression. Therefore, the resultant foam has improved recovery, but does not sacrifice any physical properties or viscoelasticity.

Table 9 illustrates a comparative example of a commercially available high density, viscoelastic foam. The comparative foam has a density of about 5.3 lbs/ft³.

TABLE 9
Properties for Comparative High Density Viscoelastic Foam.

| | Comparative Example |
|---|---|
| Physical Properties | |
| Dow Air Flow, cfm | 0.00 |
| Tensile, psi | 8.80 |
| HA Tensile, psi | 9.60 |
| Elongation, % | 175.00 |
| Tear | 0.95 |
| Resilience, % | 1.00 |
| Compression Sets, % | |
| 50% | 20.00 |
| 90% | 65.00 |
| CFD, 50%, psi | 0.29 |
| Humid Aged 3 @ 220 F. | |
| CFD, % of 50% | 61.80 |
| Compression Sets | |
| 50% | 14.00 |
| 90% | 51.00 |
| Tg (DMTA), deg C. | 28.00 |
| Fatigue Properties | |
| Stat. Fat.Thick Loss, % | 0.40 |
| Stat. Fat. 25% Loss | 1.80 |
| Stat. Fat. 65% Loss | 1.20 |
| Pound Fat. Thick Loss, % | 1.50 |
| Pound Fat. 40% Loss | 18.70 |
| Flammability | |
| California TB 117 | |
| Vertical Open Flame | |
| Char Length Ave, in. | 0.90 |
| After flame Ave, sec. | 7.20 |
| HA Char Length Ave, in. | 0.50 |
| HA after flame Ave, sec. | 0.90 |
| Cigarette Smoldering, % wt. Ret. | 99.6 |

Comparing the Comparative Example in Table 9 with the Example 20 in Table 5, both the Comparative Example and Example 20 have a similar density. The Comparative Example has a density of 5.3 lbs/ft³ and Example 20 has density of 5.7 lbs/ft³. Example 20 has better tensile, heat aged tensile, and tear resistance properties. Example 20 had a 0% height loss, whereas the Comparative Example had a loss 1.5%. Therefore, Example 20 has better fatigue properties than does the Comparative Example.

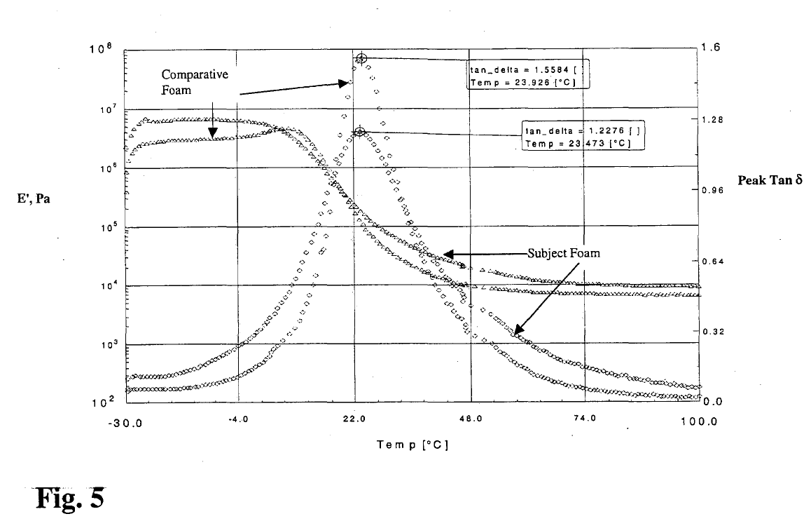

The Comparative Example has a Tg of 28° C. and Example 20 has a Tg 30.3° C., indicating that each has similar viscoelastic properties. Both pass the cigarette smoldering, but Example 20 did not pass the vertical open flame test. FIG. 5 illustrates DMTA plots for another example of a comparative viscoelastic foam having a Tg of 23.9 degrees C. and a peak tan delta of 1.56. DMTA plots for another example of a subject foam according to the subject invention is also shown in FIG. 5 having a Tg of 23.5 and a peak tan delta of 1.23.

Obviously, many modifications and variations of the present invention are possible in light of the above teachings. The invention may be practiced otherwise than as specifically described within the scope of the appended claims.

1. A viscoelastic polyurethane foam having a density of from one to thirty pounds per cubic foot, said foam comprising a reaction product of:
an isocyanate component;
an isocyanate-reactive component;
a chain extender having a backbone chain with from two to eight carbon atoms and a weight-average molecular weight of less than 1,000, wherein said chain extender is used in an amount of from 5 to 50 parts by weight based on 100 parts by weight of said foam; and
said foam having a glass transition temperature of from 5 to 65 degrees Celsius and a tan delta peak of from 0.40 to 1.75.

2. A viscoelastic polyurethane foam as set forth in claim 1 wherein said chain extender is used in an amount of from 5 to 30 parts by weight based on 100 parts by weight of said foam.

3. A viscoelastic polyurethane foam as set forth in claim 2 wherein said chain extender has a weight-average molecular weight of from 25 to 250.

4. A viscoelastic polyurethane foam as set forth in claim 1 wherein said chain extender is used in an amount of from 5 to 15 parts by weight based on 100 parts by weight of said foam.

5. A viscoelastic polyurethane foam as set forth in claim 4 wherein said chain extender has a weight-average molecular weight of less than 100.

6. A viscoelastic polyurethane foam as set forth in claim 1 wherein said chain extender has two isocyanate-reactive groups.

7. A viscoelastic polyurethane foam as set forth in claim 6 wherein said chain extender is a diol having hydroxyl groups as said isocyanate-reactive groups.

8. A viscoelastic polyurethane foam as set forth in claim 1 wherein said chain extender is further defined as having from two to six carbon atoms.

9. A viscoelastic polyurethane foam as set forth in claim 8 wherein said chain extender is selected from at least one of 1,4-butanediol, 1,3-butanediol, 2,3-butanediol, 1,2-butanediol, 1,3-propylene glycol, and 1,5-pentanediol.

10. A viscoelastic polyurethane foam as set forth in claim 9 wherein said chain extender is selected from at least one of ethylene glycol, diethylene glycol, and polyethylene glycols having a weight-average molecular weight of up to 200.

11. A viscoelastic polyurethane foam as set forth in claim 9 wherein said foam has a glass transition temperature of from 15 to 35 degrees Celsius and a tan delta peak of from 0.9 to 1.5.

12. A viscoelastic polyurethane foam as set forth in claim 1 wherein said isocyanate component is further defined as:
pure diphenylmethane diisocyanate in an amount of from 50 to 99 parts by weight based on 100 parts of said isocyanate component; and
polymeric diphenylmethane diisocyanate in an amount from 1 to 50 parts by weight based on 100 parts of said isocyanate component.

13. A viscoelastic polyurethane foam as set forth in claim 12 wherein said pure diphenylmethane diisocyanate is further defined as:
diphenylmethane-2,4′-diisocyanate in an amount of from 1 to 45 parts by weight based on 100 parts of said pure diphenylmethane diisocyanate; and
diphenylmethane-4,4′-diisocyanate in an amount from 55 to 99 parts by weight based on 100 parts of said pure diphenylmethane diisocyanate.

14. A viscoelastic polyurethane foam as set forth in claim 13 wherein said isocyanate component is further defined as an isocyanate-terminated prepolymer.

15. A viscoelastic polyurethane foam as set forth in claim 14 wherein said prepolymer comprises a reaction produce of an isocyanate and a polyol having a weight-average molecular weight greater than 1,000, said polyol being used in an amount of from 1 to 20 parts by weight based on 100 parts of said isocyanate component.

16. A viscoelastic polyurethane foam as set forth in claim 1 wherein said reaction product further comprises a cross-linker in an amount of from 2 to 18 parts by weight based on 100 parts by weight of said foam.

17. A viscoelastic polyurethane foam as set forth in claim 16 wherein said cross-linker is further defined as being an amine-based cross-linker.

18. A viscoelastic polyurethane foam as set forth in claim 17 wherein said amine-based cross-linker is selected from at least one of triethanolamine, diethanolamine, ethylene diamine and alkoxylation product thereof having a hydroxyl number of greater than 250.

19. A viscoelastic polyurethane foam as set forth in claim 1 wherein said isocyanate-reactive component comprises a polyol selected from at least one of polyether polyols and polyester polyols.

20. A viscoelastic polyurethane foam as set forth in claim 19 wherein said polyol has a hydroxyl number of from 20 to 200 mg KOH per gram of said polyol.

21. A viscoelastic polyurethane foam as set forth in claim 1 wherein said reaction product further comprises a monol in an amount of from 1 to 15 parts by weight based on 100 parts by weight of said foam.

22. A viscoelastic polyurethane foam as set forth in claim 21 wherein said monol is selected from at least one of benzyl alcohol, 2,2-dimethyl-1,3-dioxolane-4-methanol, and alcohol ethoxylate.

23. A viscoelastic polyurethane foam as set forth in claim 1 wherein said reaction product further comprises a cell opener having at least one of a paraffinic, cyclic, and aromatic hydrocarbon chain and is present in an amount of from 1 to 15 parts by weight based on 100 parts by weight of said foam.

24. A viscoelastic polyurethane foam as set forth in claim 23 wherein said cell opener is mineral oil.

25. A composition for use in forming a viscoelastic polyurethane foam having a density of from one to thirty pounds per cubic foot, said composition comprising:
an isocyanate component substantially free of toluene diisocyanate;
an isocyanate-reactive component; and
a chain extender having a backbone chain with from two to eight carbon atoms and a weight-average molecular weight of less than 1,000, wherein said chain extender is present in an amount of from 5 to 50 parts by weight based on 100 parts by weight of said composition.

26. A composition as set forth in claim 25 wherein said chain extender is present in an amount of from 5 to 30 parts by weight based on 100 parts by weight of said composition.

27. A composition as set forth in claim 26 wherein said chain extender has a weight-average molecular weight of from 25 to 250.

28. A composition as set forth in claim 25 wherein said chain extender is present in an amount of from 5 to 15 parts by weight based on 100 parts by weight of said composition.

29. A composition as set forth in claim 28 wherein said chain extender has a weight-average molecular weight of less than 100.

30. A composition as set forth in claim 25 wherein said chain extender has two isocyanate-reactive groups.

31. A composition as set forth in claim 30 wherein said chain extender is a diol having hydroxyl groups as said reactive groups.

32. A composition as set forth in claim 25 wherein said chain extender is further defined as having from two to six carbon atoms.

33. A composition as set forth in claim 32 wherein said chain extender is selected from at least one of 1,4-butanediol, 1,3-butanediol, 2,3-butanediol, 1,2-butanediol, 1,3-propylene glycol, and 1,5-pentanediol.

34. A composition as set forth in claim 32 wherein said chain extender is selected from at least one of ethylene glycol, diethylene glycol, and polyethylene glycols having a weight-average molecular weight of up to 200.

35. A composition as set forth in claim 25 wherein said isocyanate component is further defined as:
pure diphenylmethane diisocyanate present in an amount of from 50 to 99 parts by weight based on 100 parts of said isocyanate component; and
polymeric diphenylmethane diisocyanate present in an amount from 1 to 50 parts by weight based on 100 parts of said isocyanate component.

36. A composition as set forth in claim 35 wherein said pure diphenylmethane diisocyanate is further defined as:
diphenylmethane-2,4′-diisocyanate present in an amount of from 1 to 45 parts by weight based on 100 parts of said pure diphenylmethane diisocyanate; and
diphenylmethane-4,4′-diisocyanate present in an amount from 55 to 99 parts by weight based on 100 parts of said pure diphenylmethane diisocyanate.

37. A composition as set forth in claim 25 wherein said isocyanate component comprises an isocyanate-terminated prepolymer.

38. A composition as set forth in claim 37 wherein said prepolymer comprises a reaction product of an isocyanate and a polyol having a weight-average molecular weight greater than 1,000, said polyol present in an amount of from 1 to 20 parts by weight based on 100 parts of said isocyanate component.

39. A composition as set forth in claim 38 wherein said composition further comprises a cross-linker in an amount of from 2 to 18 parts by weight based on 100 parts by weight of said composition.

40. A composition as set forth in claim 39 wherein said cross-linker is further defined as being an amine-based cross-linker.

41. A composition as set forth in claim 40 wherein said amine-based cross-linker is further defined as being selected from at least one of triethanolamine, diethanolamine, and ethylene diamine.

42. A composition as set forth in claim 25 wherein said isocyanate-reactive component is further defined as being a polyol selected from at least one of polyether polyols and polyester polyols.

43. A composition as set forth in claim 42 wherein said polyol has a hydroxyl number of from 20 to 200 mg KOH per gram of said polyol.

44. A composition as set forth in claim 25 wherein said composition further comprises a monol present in an amount of from 1 to 15 parts by weight based on 100 parts by weight of said composition.

45. A composition as set forth in claim 44 wherein said monol is selected from at least one of benzyl alcohol, 2,2-dimethyl-1,3-dioxolane-4-methanol, and alcohol ethoxylate.

46. A composition as set forth in claim 25 wherein said composition further comprises a cell opener selected having at least one of a paraffinic, cyclic, and aromatic hydrocarbon chain and is present in an amount of from 1 to 15 parts by weight based on 100 parts by weight of said composition.

47. A composition as set forth in claim 46 wherein said cell opener is mineral oil.

48. A method of forming a viscoelastic polyurethane foam comprising the steps of:
providing an isocyanate component substantially free of flame retardant;
providing an isocyanate-reactive component;
providing a chain extender having a backbone chain with from two to eight carbon atoms and a weight-average molecular weight of less than 1,000, wherein the chain extender is used in an amount of from 5 to 50 parts by weight based on 100 parts by weight of the foam; and
reacting the isocyanate component, the isocyanate-reactive component, and the chain extender to form the foam having a glass transition temperature of from 5 to 65 degrees Celsius and a tan delta peak of from 0.40 to 1.75.

49. A method as set forth in claim 48 wherein the step of providing the chain extender is further defined as providing the chain extender in an amount of from 5 to 30 parts by weight based on 100 parts by weight of the foam.

50. A method as set forth in claim 49 wherein the step of providing the chain extender is further defined as providing the chain extender having a weight-average molecular weight of from 25 to 250.

51. A method as set forth in claim 48 wherein the step of providing the chain extender is further defined as providing the chain extender in an amount of from 5 to 15 parts by weight based on 100 parts by weight of the foam.

52. A method as set forth in claim 51 wherein the step of providing the chain extender is further defined as providing the chain extender having a weight-average molecular weight of less than 100.

53. A method as set forth in claim 48 wherein the step of providing the chain extender is further defined as providing the chain extender having two isocyanate-reactive groups.

54. A method as set forth in claim 53 wherein the step of providing the chain extender is further defined as providing the chain extender as a diol having hydroxyl groups as the isocyanate-reactive groups.

55. A method as set forth in claim 48 wherein the step of providing the chain extender is further defined as providing the chain extender having from two to six carbon atoms.

56. A method as set forth in claim 55 wherein the step of providing the chain extender is further defined as providing the chain extender selected from at least one of 1,4-butanediol, 1,3-butanediol, 2,3-butanediol, 1,2-butanediol, 1,3-propylene glycol, and 1,5-pentanediol.

57. A method as set forth in claim 56 wherein the step of providing the chain extender is further defined as providing the chain extender selected from at least one of ethylene glycol, diethylene glycol, and polyethylene glycols having a weight-average molecular weight of up to 200.

58. A method as set forth in claim 57 wherein the step of reacting the isocyanate component, the isocyanate-reactive component, and the chain extender forms the foam having a glass transition temperature of from 15 to 35 degrees Celsius and a tan delta peak of from 0.9 to 1.5.
